(19) United States
(12) Patent Application Publication
(10) Pub. No.: US 2026/0369478 A1
(43) Pub. Date: Nov. 19, 2026

(54) MULTILAYER CERAMIC CAPACITOR AND METHOD FOR MANUFACTURING MULTILAYER CERAMIC CAPACITOR

(71) Applicant: Murata Manufacturing Co., Ltd., Nagaokakyo-shi (JP)

(72) Inventors: Ryosuke AKAZAWA, Nagaokakyo-shi (JP); Yasushi YOSHIDA, Nagaokakyo-shi (JP)

(21) Appl. No.: 19/733,126

(22) Filed: Jul. 7, 2026

Related U.S. Application Data
(63) Continuation of application No. PCT/JP2024/039943, filed on Nov. 11, 2024.

(30) Foreign Application Priority Data
Jan. 12, 2024 (JP) 2024-003096

(51) Int. Cl. H01G 4/30; H01G 4/232

(52) U.S. Cl. CPC H01G 4/30; H01G 4/2325

(57) ABSTRACT

A multilayer ceramic capacitor includes a multilayer body including ceramic layers and inner electrode layers, and an outer electrode connected to the inner electrode layers. A base electrode layer of the outer electrode includes a conductive metal, and a glass including Si and Ba. The glass includes a first glass including a surface layer and a near-surface-layer region. The surface layer includes a compound in which Ba and P are bonded in a portion of the first glass exposed from a surface of the base electrode layer. The near-surface-layer region is adjacent to the surface layer and is in at least one of a location inside the surface layer or a location that is closer to the multilayer body than the surface layer. The near-surface-layer region includes a content of the compound less than a content of the compound in the surface layer.

### CROSS REFERENCE TO RELATED APPLICATIONS

This application claims the benefit of priority to Japanese Patent Application No. 2024-003096 filed on Jan. 12, 2024 and is a Continuation application of PCT Application No. PCT/JP2024/039943 filed on Nov. 11, 2024. The entire contents of each application are hereby incorporated herein by reference.

### BACKGROUND OF THE INVENTION

### 1. Field of the Invention

The present invention relates to multilayer ceramic capacitors, and methods for manufacturing multilayer ceramic capacitors.

### 2. Description of the Related Art

Significant demand is expected for multilayer ceramic capacitors (MLCCs) as, for example, electronic components incorporated in automobiles and mobile phones. Multilayer ceramic capacitors include a multilayer body and an outer electrode. The multilayer body includes inner electrode layers and ceramic layers.

Such a multilayer ceramic capacitor includes a multilayer body in which a plurality of ceramic layers and a plurality of inner electrode layers are stacked, with an outer electrode disposed on the outer surface of the multilayer body. Each inner electrode layer is extended to an end surface or side surface of the multilayer body, and connected to the outer electrode. The outer electrode includes, for example, a base electrode layer, which is formed by firing of a conductive paste applied on the multilayer body, and a plating layer formed on the outer surface of the base electrode layer. The plating layer may include a plurality of layers as required.

For example, Japanese Unexamined Patent Application Publication No. 2007-294633 discloses a conductive paste for a base electrode. The conductive paste enables formation of an outer electrode (including a base electrode layer) that is configured to prevent intrusion of a plating solution and that allows for enhanced connectivity with the inner electrode layers. The conductive paste for the base electrode in Japanese Unexamined Patent Application Publication No. 2007-294633 includes metal powder with an adjusted particle size. This allows for improved packing density of the metal powder, and consequently a dense sintered body. This in turn reduces the intrusion of the plating solution and improves the reliability of the multilayer ceramic capacitor. Further, limiting the amount of glass powder in the conductive paste to a predetermined range also reduces the intrusion of the plating solution and improves the reliability of the multilayer ceramic capacitor.

As described above, the configuration according to Japanese Unexamined Patent Application Publication No. 2007-294633 improves the reliability of the multilayer ceramic capacitor by adjusting the particle size of the metal powder and the amount of glass powder in the conductive paste. However, there is also a demand for improving the reliability of the multilayer ceramic capacitor through a configuration different from that according to Japanese Unexamined Patent Application Publication No. 2007-294633. In this regard, the inventors of example embodiments of the present invention have discovered a novel configuration that, through a configuration different from that according to Japanese Unexamined Patent Application Publication No. 2007-294633, reduces the intrusion of the plating solution and improves the reliability of the multilayer ceramic capacitor.

### SUMMARY OF THE INVENTION

Example embodiments of the present invention provide multilayer ceramic capacitors each providing improved reliability, and methods for manufacturing such multilayer ceramic capacitors.

A multilayer ceramic capacitor according to an example embodiment of the present invention includes a multilayer body and an outer electrode. The multilayer body includes a plurality of ceramic layers and a plurality of inner electrode layers. The outer electrode is connected to the plurality of inner electrode layers at a location where the plurality of inner electrode layers are exposed from the multilayer body. The outer electrode includes a base electrode layer, and a plating layer on the base electrode layer. The base electrode layer includes a conductive metal, and a glass including Si and Ba. The glass includes a first glass. The first glass includes a surface layer and a near-surface-layer region. The surface layer includes a compound in which Ba and P are bonded in a portion of the first glass exposed from a surface of the base electrode layer. The near-surface-layer region is adjacent to the surface layer. The near-surface-layer region is located in at least one of a location inside the surface layer or a location that is closer to the multilayer body than the surface layer. The near-surface-layer region has a content of the compound less than a content of the compound in the surface layer.

In multilayer ceramic capacitors according to example embodiments of the present invention, the compound that is included in the surface layer of the first glass and in which Ba and P are bonded reduces dissolution of the first glass into the plating solution. Therefore, the surface layer defines and functions as a barrier film against the plating solution. This helps to reduce the erosion of the first glass by the plating solution, and reduce the intrusion of the plating solution into the interior of the multilayer ceramic capacitor. This in turn achieves improved reliability of the multilayer ceramic capacitor.

A method for manufacturing a multilayer ceramic capacitor according to an example embodiment of the present invention includes preparing a multilayer body, the multilayer body including a plurality of ceramic layers and a plurality of inner electrode layers, forming a base electrode layer on the multilayer body, the base electrode layer including a conductive metal and a glass, forming a first glass as a portion of the glass by immersing, in a solution including P, the multilayer body on which the base electrode layer is formed, and forming, by forming a plating layer on the base electrode layer, an outer electrode as a stack of the plating layer and the base electrode layer. The first glass includes a surface layer and a near-surface-layer region. The surface layer includes a compound in which Ba and P are bonded in a portion of the first glass exposed from a surface of the base electrode layer. The near-surface-layer region is located adjacent to the surface layer. The near-surface-layer region is located in at least one of a location inside the surface layer or a location that is closer to the multilayer body than the surface layer. The near-surface-layer region includes a content of the compound less than a content of the compound in the surface layer.

In multilayer ceramic capacitors manufactured by manufacturing methods according to example embodiments of the present invention, the compound that is included in the surface layer of the first glass and in which Ba and P are bonded reduces dissolution of the first glass into the plating solution. Therefore, the surface layer defines and functions as a barrier film against the plating solution. This helps to reduce the erosion of the first glass by the plating solution, and reduce the intrusion of the plating solution into the interior of the multilayer ceramic capacitor. This in turn achieves improved reliability of the multilayer ceramic capacitor.

Example embodiments of the present invention provide multilayer ceramic capacitors configured to provide improved reliability, and methods for manufacturing such multilayer ceramic capacitors.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of an example of a multilayer ceramic capacitor according to an example embodiment of the present invention.

FIG. 2 is a cross-sectional view taken along a line II-II in FIG. 1.

FIG. 3 is a cross-sectional view taken along a line III-III in FIG. 1.

FIG. 4 is a partial enlarged cross-sectional view of a first outer electrode.

FIGS. 5A to 5D illustrate, in partial enlarged cross-section, an example of the positional relationships between individual regions in a first glass.

FIG. 6A schematically illustrates how a surface layer is formed in the first glass, and FIG. 6B schematically illustrates how a near-surface-layer region and an inner region are formed in the first glass.

### DETAILED DESCRIPTION OF THE EXAMPLE EMBODIMENTS

Example embodiments of the present invention are described in detail below with reference to the drawings

A multilayer ceramic capacitor will now be described as an example of a multilayer ceramic electronic component according to an example embodiment of the present invention. According to the present example embodiment, the multilayer ceramic capacitor is, for example, a two-terminal multilayer ceramic capacitor.

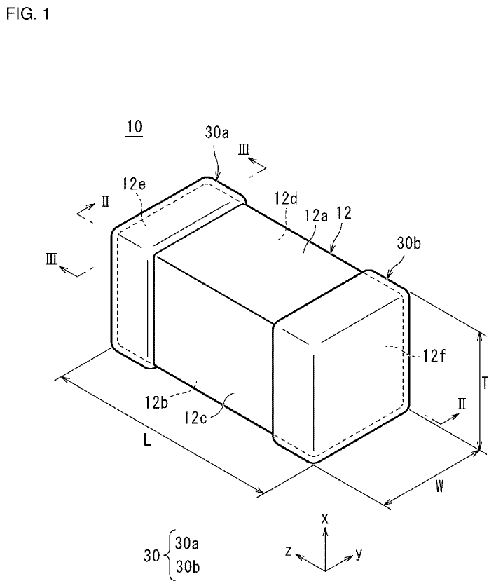

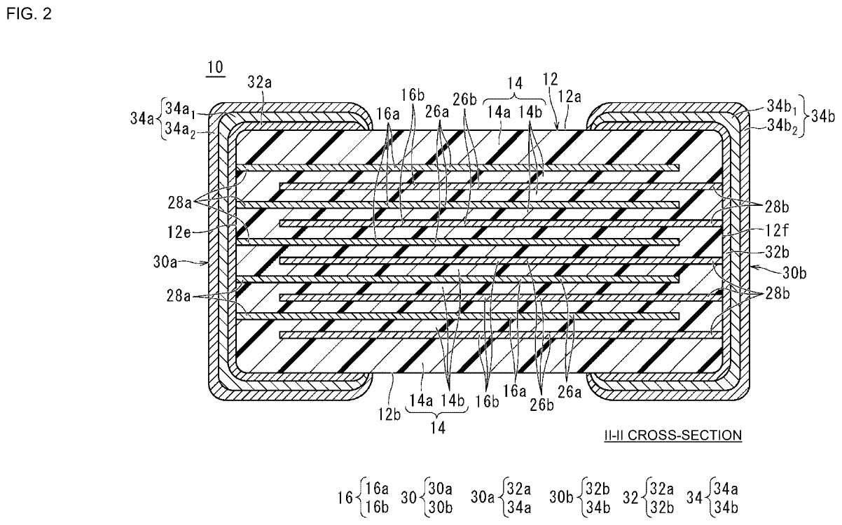

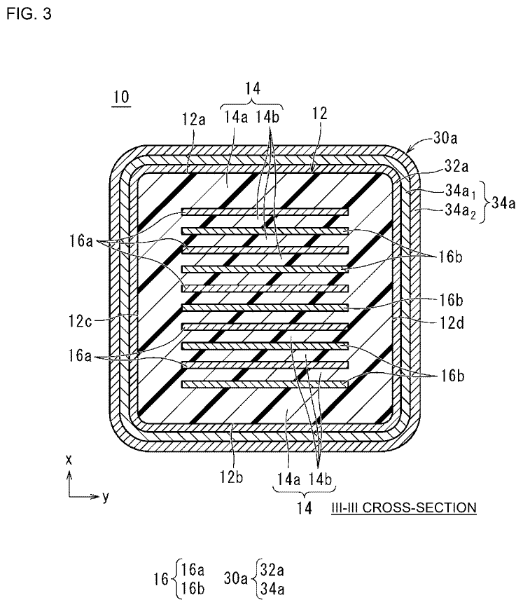

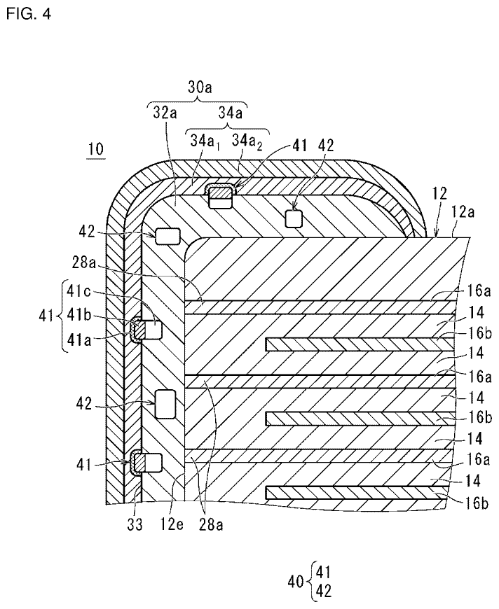

FIG. 1 is an external perspective view of an example of a multilayer ceramic capacitor, which is the multilayer ceramic electronic component according to the present example embodiment of the present invention. FIG. 2 is a cross-sectional view taken along a line II-II in FIG. 1. FIG. 3 is a cross-sectional view taken along a line III-III in FIG. 1. FIG. 4 is a partial enlarged cross-sectional view of a first outer electrode.

As illustrated in FIGS. 1 to 4, a multilayer ceramic capacitor 10 includes a cuboid multilayer body 12, and an outer electrode 30 disposed on each end portion of the multilayer body 12.

The multilayer body 12 includes a first major surface 12a, a second major surface 12b, a first side surface 12c, a second side surface 12d, a first end surface 12e, and a second end surface 12f. The first major surface 12a and the second major surface 12b are opposite to each other in a height direction x (a stacking direction). The first side surface 12c and the second side surface 12d are opposite to each other in a width direction y orthogonal to the height direction x. The first end surface 12e and the second end surface 12f are opposite to each other in a length direction z orthogonal to the height direction x and to the width direction y. According to the present example embodiment, the multilayer body 12 includes rounded corners and edges. In this regard, a corner is where three surfaces of the multilayer body 12 meet, and an edge is where two adjacent surfaces of the multilayer body 12 meet. The first major surface 12a and the second major surface 12b, the first side surface 12c and the second side surface 12d, and the first end surface 12e and the second end surface 12f may include, for example, projections and depressions in a portion or in an entirety thereof.

The multilayer body 12 includes an outer layer portion 14a including a plurality of ceramic layers 14, and an inner layer portion 14b including one or more ceramic layers 14 and a plurality of inner electrode layers 16 disposed on the one or more ceramic layers 14. The outer layer portion 14a is located at the first major surface 12a and the second major surface 12b of the multilayer body 12. The outer layer portion 14a represents a group of the following layers: a plurality of ceramic layers 14 (a first outer layer portion) located between the first major surface 12a and the inner electrode layer 16 located closest to the first major surface 12a, and a plurality of ceramic layers 14 (a second outer layer portion) located between the second major surface 12b and the inner electrode layer 16 located closest to the second major surface 12b. The region sandwiched between the outer layer portions 14a at opposite sides is the inner layer portion 14b. In the inner layer portion 14b, the ceramic layer 14 and the inner electrode layer 16 are stacked alternately in the height direction x.

A portion of the multilayer body 12 that is sandwiched between the first outer layer portion and the second outer layer portion and where first and second electrode layers 16a and 16b (described later) of the multilayer body 12 face each other is referred to as an opposed portion (an effective layer portion). A portion between the opposed portion and the first side surface 12c, and a portion between the opposed portion and the second side surface 12d are each referred to as a W gap or a side gap. A portion between the opposed portion and the first end surface 12e, and a portion between the opposed portion and the second end surface 12f, which are portions including an extended electrode portion of one of the first inner electrode layer 16a or the second inner electrode layer 16b, are each referred to as an L gap or an end gap.

In a preferred but non-limiting example, the multilayer body 12 is dimensioned, for example, such that the dimension in the length direction z is greater than or equal to 0.39 mm and less than or equal to 3.30 mm, the dimension in the height direction x is greater than or equal to 0.21 mm and less than or equal to 2.70 mm, and the dimension in the width direction y is greater than or equal to 0.21 mm and less than or equal to 2.70 mm.

An example of the dielectric material of the ceramic layer 14 may be a dielectric ceramic material including a component such as BaTiO₃, CaTiO₃, SrTiO₃, or CaZrO₃. If the material to be used includes the above-mentioned dielectric material as its major component, then, depending on desired characteristics of the multilayer body 12, the material to be used may include a minor component such as, for example, a Mn compound, an Fe compound, a Cr compound, a Co compound, or a Ni compound added at a content less than that of the major component.

Preferably, for example, the thickness of the ceramic layer 14 after firing is greater than or equal to 0.2 μm and less than or equal to 2 μm. The number of ceramic layers 14 to be stacked is preferably, for example, greater than or equal to 15 and less than or equal to 1000. More preferably, the above-mentioned thickness is, for example, greater than or equal to 0.2 μm and less than or equal to 0.55 μm. This makes it possible to increase the number of stacked sheets, which in turn contributes to increased capacitance. The number of ceramic layers 14 in this case is the sum of the number of ceramic layers 14 in the inner layer portion 14b, the number of ceramic layers 14 in the outer layer portion 14a located at the first major surface 12a, and the number of ceramic layers 14 in the outer layer portion 14a located at the second major surface 12b.

The multilayer body 12 includes, as the inner electrode layers 16, a plurality of first inner electrode layers 16a extended to the first end surface 12e, and a plurality of second inner electrode layers 16b extended to the second end surface 12f. The first inner electrode layers 16a and the second inner electrode layers 16b are embedded in the inner layer portion 14b so as to be arranged alternately in the height direction x of the multilayer body 12 at equal intervals with the ceramic layer 14 sandwiched between. The surfaces of the first inner electrode layers 16a and the surfaces of the second inner electrode layers 16b are generally parallel to the first major surface 12a and the second major surface 12b, and are, for example, substantially rectangular in plan view.

The first inner electrode layers 16a are disposed on the corresponding ceramic layers 14, and located in the interior of the multilayer body 12. Each first inner electrode layer 16a includes a first counter electrode portion 26a and a first extended electrode portion 28a. The first counter electrode portion 26a faces the second inner electrode layer 16b. The first extended electrode portion 28a is located at one end of the first inner electrode layer 16a, and extends from the first counter electrode portion 26a to the first end surface 12e of the multilayer body 12. An end portion of the first extended electrode portion 28a is extended to the surface of the first end surface 12e, and exposed from the multilayer body 12. In other words, the first extended electrode portion 28a is exposed on none of the first major surface 12a, the second major surface 12b, the first side surface 12c, the second side surface 12d, and the second end surface 12f. An end portion of the first counter electrode portion 26a is located at a retracted position in the width direction relative to the surface of the second end surface 12f.

Although not particularly limited, the shape of the first counter electrode portion 26a of the first inner electrode layer 16a is, for example, preferably a rectangular shape in plan view. The shape, however, may include rounded corners in plan view, or may include oblique (tapered) corners in plan view. Alternatively, the shape may be a tapered shape in plan view that is tapered toward one end.

Although not particularly limited, the shape of the first extended electrode portion 28a of the first inner electrode layer 16a is, for example, preferably a rectangular shape in plan view. The shape, however, may include rounded corners in plan view, or may include oblique (tapered) corners in plan view. Alternatively, the shape may be a tapered shape in plan view that is tapered toward one end.

The first counter electrode portion 26a of the first inner electrode layer 16a, and the first extended electrode portion 28a of the first inner electrode layer 16a may have the same width, or one of the two electrode portions may be narrower than the other.

The second inner electrode layers 16b are disposed on the corresponding ceramic layers 14, and located in the interior of the multilayer body 12. Each second inner electrode layer 16b includes a second counter electrode portion 26b, and a second extended electrode portion 28b. The second counter electrode portion 26b faces the first inner electrode layer 16a. The second extended electrode portion 28b is located at one end of the second inner electrode layer 16b, and extends from the second counter electrode portion 26b to the second end surface 12f of the multilayer body 12. An end portion of the second extended electrode portion 28b is extended to the surface of the second end surface 12f, and exposed from the multilayer body 12. In other words, the second extended electrode portion 28b is exposed on none of the first major surface 12a, the second major surface 12b, the first side surface 12c, the second side surface 12d, and the first end surface 12e. An end portion of the second counter electrode portion 26b is located at a retracted position in the width direction relative to the surface of the first end surface 12e.

Although not particularly limited, the shape of the second counter electrode portion 26b of the second inner electrode layer 16b is, for example, preferably a rectangular shape in plan view. The shape, however, may include rounded corners in plan view, or may include oblique (tapered) corners in plan view. Alternatively, the shape may be a tapered shape in plan view that is tapered toward one end.

Although not particularly limited, the shape of the second extended electrode portion 28b of the second inner electrode layer 16b is, for example, preferably a rectangular shape in plan view. The shape, however, may include rounded corners in plan view, or may include oblique (tapered) corners in plan view. Alternatively, the shape may be a tapered shape in plan view that is tapered toward one end.

The second counter electrode portion 26b of the second inner electrode layer 16b, and the second extended electrode portion 28b of the second inner electrode layer 16b may have the same width, or one of the two electrode portions may be narrower than the other.

The first inner electrode layer 16a and the second inner electrode layer 16b may be made of any suitable conductive material, examples of which include metals such as Ni, Cu, Ag, Pd, or Au and alloys including at least one of these metals, such as an Ag—Pd alloy. In a case where the multilayer body 12 including the inner electrode layer 16, and the outer electrode 30 on the surface of the multilayer body 12 are to be fired simultaneously as an integral portion, a metal of the inner electrode layer 16 includes a metal and a compound that are included in the outer electrode 30.

Preferably, for example, the thickness of the inner electrode layer 16, that is, the thickness of each of the first inner electrode layer 16a and the second inner electrode layer 16b is greater than or equal to 0.2 μm and less than or equal to 2.0 μm. More preferably, for example, the thickness is greater than or equal to 0.2 μm and less than or equal to 0.5 μm.

Preferably, the sum of the number of first inner electrode layers 16a and the number of second inner electrode layers 16b is, for example, greater than or equal to 15 and less than or equal to 1000.

As illustrated in FIGS. 1 to 3, the outer electrode 30 is disposed at the first end surface 12e and the second end surface 12f of the multilayer body 12.

The outer electrode 30 includes a first outer electrode 30a and a second outer electrode 30b.

The first outer electrode 30a is connected to the first inner electrode layer 16a, and disposed on the surface of at least the first end surface 12e. In this case, the first outer electrode 30a is electrically connected to the first extended electrode portion 28a of the first inner electrode layer 16a. According to the present example embodiment, the first outer electrode 30a extends from the first end surface 12e such that the first outer electrode 30a is disposed also on a portion of the first major surface 12a and a portion of the second major surface 12b, as well as on a portion of the first side surface 12c and a portion of the second side surface 12d.

The second outer electrode 30b is connected to the second inner electrode layer 16b, and disposed on the surface of at least the second end surface 12f. In this case, the second outer electrode 30b is electrically connected to the second extended electrode portion 28b of the second inner electrode layer 16b. According to the present example embodiment, the second outer electrode 30b extends from the second end surface 12f such that the second outer electrode 30b is disposed also on a portion of the first major surface 12a and a portion of the second major surface 12b, as well as on a portion of the first side surface 12c and a portion of the second side surface 12d.

Within the multilayer body 12, as the first counter electrode portion 26a of the first inner electrode layer 16a and the second counter electrode portion 26b of the second inner electrode layer 16b face each other with the ceramic layer 14 interposed therebetween, a capacitance is generated. As a result, a capacitance can be generated between the first outer electrode 30a, which is connected with the first inner electrode layer 16a, and the second outer electrode 30b, which is connected with the second inner electrode layer 16b. This provides capacitor characteristics.

The outer electrode 30 preferably includes a base electrode layer 32 and a plating layer 34. According to the present example embodiment, the outer electrode 30 includes the base electrode layer 32, and the plating layer 34 disposed on the base electrode layer 32. The plating layer 34 includes a first plating layer 34a and a second plating layer 34b.

The first outer electrode 30a includes a first base electrode layer 32a, a first lower plating layer 34ai disposed on the first base electrode layer 32a, and a first upper plating layer 34a2 disposed on the first lower plating layer 34ai.

The second outer electrode 30b includes a second base electrode layer 32b, a second lower plating layer 34b₁ disposed on the second base electrode layer 32b, and a second upper plating layer 34b2 disposed on the second lower plating layer 34b₁.

The first base electrode layer 32a is connected to the first inner electrode layer 16a, and exposed on the surface of the first end surface 12e. In this case, the first base electrode layer 32a is electrically connected to the first extended electrode portion 28a of the first inner electrode layer 16a. According to the present example embodiment, the first base electrode layer 32a extends from the first end surface 12e such that the first base electrode layer 32a is disposed also on a portion of the first major surface 12a and a portion of the second major surface 12b, as well as on a portion of the first side surface 12c and a portion of the second side surface 12d.

The second base electrode layer 32b is connected to the second inner electrode layer 16b, and disposed on the surface of the second end surface 12f. In this case, the second base electrode layer 32b is electrically connected to the second extended electrode portion 28b of the second inner electrode layer 16b. According to the present example embodiment, the second base electrode layer 32b extends from the second end surface 12f such that the second base electrode layer 32b is disposed also on a portion of the first major surface 12a and a portion of the second major surface 12b, as well as on a portion of the first side surface 12c and a portion of the second side surface 12d.

The base electrode layer 32 includes a conductive metal and a glass. The conductive metal in the base electrode layer 32 includes at least one of, for example, Cu, Ni, Ag, Pb, an Ag—Pb alloy, or Au. The conductive metal according to the present example embodiment is, for example, mainly Cu. The glass in the base electrode layer 32 mainly includes, for example, Si and Ba. Further, the glass in the base electrode layer 32 may preferably include at least one of, for example, Al, B, Pd, Mg, or Li. The glass according to the present example embodiment mainly includes, for example, Si, Ba, and Al as its components. According to the present example embodiment, a glass 40 is configured to reduce leaching of the glass 40 when plating is performed on the base electrode layer 32. Specifically, as will be described later, the glass 40 includes a first glass 41. The first glass 41 includes, for example, a compound in which Ba and P are bonded and that is insoluble in a plating solution used during plating. Therefore, according to the present example embodiment, for example, the first glass 41 includes Si, Ba, and Al as well as P as its components.

The base electrode layer 32 may include a plurality of layers. The base electrode layer 32 is formed by applying a conductive paste including metal powder and glass powder onto the multilayer body 12 and baking the applied conductive paste. The base electrode layer 32 may be fired simultaneously with the ceramic layer 14 and the inner electrode layer 16, or may be baked after the ceramic layer 14 and the inner electrode layer 16 are fired. The inclusion of the glass in the base electrode layer 32 allows for improved adhesion between the multilayer body 12 and the base electrode layer 32.

First and second baked layers as the first and second base electrode layers 32a and 32b respectively disposed on the first and second end surfaces 12e and 12f each preferably have a thickness in an approximate range of, for example, greater than or equal to 3 μm and less than or equal to 20 μm in a central portion in the height direction x.

In a case where the base electrode layer 32 is disposed on the first major surface 12a and the second major surface 12b and on the first side surface 12c and the second side surface 12d, the first and second baked layers as the first and second base electrode layers 32a and 32b disposed on the first and second major surfaces 12a and 12b and on the first and second side surfaces 12c and 12d each preferably have a thickness in an approximate range of, for example, greater than or equal to 1 μm and less than or equal to 20 μm in a central portion in the length direction z.

The glass 40 included in the base electrode layer 32 will now be described further. As illustrated in FIG. 4, the glass 40 includes the first glass 41 and a second glass 42. A portion of the first glass 41 is exposed on a surface 33 of the base electrode layer 32. In contrast, the second glass 42, which is located closer to the multilayer body 12 than the surface 33 of the base electrode layer 32, is not exposed on the surface 33 of the base electrode layer 32.

According to the present example embodiment, the first glass 41 includes, for example, as its components, Si, Ba, and Al as well as P. The first glass 41 includes a surface layer 41a, a near-surface-layer region 41b, and an inner region 41c.

The surface layer 41a is a portion of the first glass 41 that is exposed from the surface 33 of the base electrode layer 32. That is, the surface layer 41a is a layer located on the surface of the first glass 41 exposed from the surface 33 of the base electrode layer 32.

The near-surface-layer region 41b is located adjacent to the surface layer 41a, and is disposed in at least one of a location inside the surface layer 41a or a location that is closer to the multilayer body 12 than the surface layer 41a. When it is stated herein that the near-surface-layer region 41b is disposed in a location inside the surface layer 41a, this means that the near-surface-layer region 41b is covered by the surface layer 41a with the near-surface-layer region 41b either in contact or not in contact with the surface layer 41a. As used herein, the term “covered” does not mean that the entire periphery of the near-surface-layer region 41b is covered by the surface layer 41a, but means that the near-surface-layer region 41b is covered in a portion thereof that protrudes from the surface 33 of the base electrode layer 32.

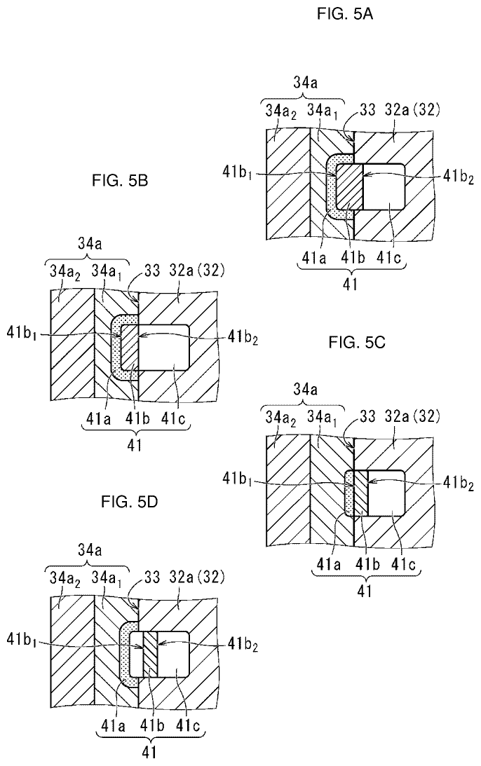

Reference will now be made to FIGS. 5A to 5D to describe where the near-surface-layer region 41b is located. FIGS. 5A to 5D illustrate, in partial enlarged cross-section, an example of the positional relationships between individual regions in the first glass.

An example of the positional relationship between the near-surface-layer region 41b and the surface layer 41a is illustrated in FIG. 5A. In FIG. 5A, a portion of the near-surface-layer region 41b protrudes from the surface 33 of the base electrode layer 32. That is, the near-surface-layer region 41b is a continuous combination of the following portions: a portion protruding from the surface 33 of the base electrode layer 32, and a portion that is located closer to the multilayer body 12 than the surface 33 of the base electrode layer 32. The protruding portion of the near-surface-layer region 41b is covered by the surface layer 41a with a surface 41b₁ of the protruding portion in contact with the surface layer 41a, and is located inside the surface layer 41a. The portion that is located closer to the multilayer body 12 than the surface 33 of the base electrode layer 32 refers to a portion of the near-surface-layer region 41b other than the portion protruding from the surface 33 of the base electrode layer 32. In an alternative configuration, another layer may be interposed between the near-surface-layer region 41b and the surface layer 41a such that the surface 41b₁ is not in contact with the surface layer 41a.

Another example of the positional relationship between the near-surface-layer region 41b and the surface layer 41a is illustrated in FIG. 5B. In FIG. 5B, the entire near-surface-layer region 41b protrudes from the surface 33 of the base electrode layer 32. The entire near-surface-layer region 41b is covered by the surface layer 41a with the surface 41b₁ thereof in contact with the surface layer 41a, and is located inside the surface layer 41a. Preferably, a back 41b₂ of the near-surface-layer region 41b, which is a side of the near-surface-layer region 41b located toward the multilayer body 12, is generally flush with the surface 33 of the base electrode layer 32. In an alternative configuration, another layer may be interposed between the near-surface-layer region 41b and the surface layer 41a such that the surface 41b₁ is not in contact with the surface layer 41a.

Another example of the positional relationship between the near-surface-layer region 41b and the surface layer 41a is illustrated in FIG. 5C. In FIG. 5C, the surface 41b₁ of the near-surface-layer region 41b is generally flush with the surface 33 of the base electrode layer 32, and the entire near-surface-layer region 41b is located closer to the multilayer body 12 than the surface layer 41a, with the surface 41b₁ being in contact with the surface layer 41a.

Another example of the positional relationship between the near-surface-layer region 41b and the surface layer 41a is illustrated in FIG. 5D. In FIG. 5D, the entire near-surface-layer region 41b is located closer to the multilayer body 12 than the surface 33 of the base electrode layer 32. Another layer is interposed between the near-surface-layer region 41b and the surface layer 41a, and the entire near-surface-layer region 41b is located closer to the multilayer body 12 than the surface layer 41a, with the surface 41b₁ not in contact with the surface layer 41a.

When it is stated herein that the near-surface-layer region 41b is located adjacent to the surface layer 41a, this includes the near-surface-layer region 41b being in contact with the surface layer 41a, and the near-surface-layer region 41b being located in the vicinity of, but not in contact with, the surface layer 41a.

The inner region 41c, which is located in the interior of the base electrode layer 32, is disposed adjacent to the near-surface-layer region 41b at a location that is closer to the multilayer body 12 than the near-surface-layer region 41b. When it is stated herein that the inner region 41c is located adjacent to the near-surface-layer region 41b, this includes the inner region 41c being in contact with the near-surface-layer region 41b, and the inner region 41c being located in the vicinity of, but not in contact with, the near-surface-layer region 41b.

The surface layer 41a includes a compound in which Ba and P are bonded. The compound in which Ba and P are bonded and that is included in the surface layer 41a reduces the dissolution of the first glass 41 into the plating solution. That is, in forming the plating layer 34 on the base electrode layer 32 using the plating solution, the surface layer 41a, which is a portion of the first glass 41 exposed on the base electrode layer 32, includes therein a compound in which Ba and P are bonded and that is not prone to dissolution in the plating solution. Therefore, the surface layer 41a defines and functions as a barrier film against the plating solution. This reduces the risk of the first glass 41 being eroded by the plating solution.

Dissolution of the glass 40 into the plating solution leads to, for example, issues described below. Examples of such issues may include a case where erosion of the base electrode layer 32 by the plating solution leads to deterioration in the evenness of the surface 33 of the base electrode layer 32, a case where erosion of the base electrode layer 32 by the plating solution leads to breaks in the base electrode layer 32, and a case where the plating solution penetrates into the interior of the multilayer ceramic capacitor 10 through the eroded portion. With the multilayer ceramic capacitor 10 configured as described above, however, the presence of the first glass 41 in the base electrode layer 32 makes it possible to mitigate the issues mentioned above. That is, the reduced risk of erosion of the first glass 41 by the plating solution makes it possible to mitigate the following issues: the deterioration in the evenness of the surface 33 of the base electrode layer 32 due to the erosion by the plating solution, the formation of breaks in the base electrode layer 32 due to the erosion by the plating solution, and the penetration of the plating solution into the interior of the multilayer ceramic capacitor 10.

As a result, for example, the following issues can be mitigated when plating is performed on the base electrode layer 32: poor plating adhesion to the base electrode layer 32, deterioration in the conductivity of the base electrode layer 32, and deterioration in the reliability of the multilayer ceramic capacitor 10 against moisture. This makes it possible to achieve improved reliability.

According to the present example embodiment, the compound in which Ba and P are bonded, which is present in the surface layer 41a, is, for example, a barium pyrophosphate 2.35-hydrate. The barium pyrophosphate 2.35-hydrate, which is a substance insoluble in water, is capable of reducing leaching of the first glass 41 into the plating solution.

The content of the compound in which Ba and P are bonded that exists in the near-surface-layer region 41b is less than the content of the compound in which Ba and P are bonded that exists in the surface layer 41a. Alternatively, in the near-surface-layer region 41b, the compound in which Ba and P are bonded is almost nonexistent, or is nonexistent. The content of Ba not bonded to P in the near-surface-layer region 41b is greater than the content of Ba not bonded to P in the surface layer 41a. For example, all of the Ba atoms present in the near-surface-layer region 41b are not bonded to P, or even if Ba bonded to P exists in the near-surface-layer region 41b, the content of Ba bonded to P is less than that in the surface layer 41a. As a result, Ba not bonded to P can exist in the near-surface-layer region 41b as, for example, Ba oxide. This allows for increased adhesion between the inner electrode layer 16 and the base electrode layer 32.

The content of Si in the near-surface-layer region 41b is greater than the content of Si in the surface layer 41a. Although the surface layer 41a has a reduced content of Si, the content of Si is maintained in the near-surface-layer region 41b to ensure increased adhesion between the inner electrode layer 16 and the base electrode layer 32.

The content of Al in the near-surface-layer region 41b is greater than the content of Al in the surface layer 41a. Although the surface layer 41a has a reduced content of Al, the content of Al can be maintained in the near-surface-layer region 41b. In this case, for example, Al may exist as Al oxide. The presence of such Al oxide improves the chemical durability of the first glass 41, and reduces the risk of an excessive increase in thermal expansion coefficient. The content of Al in the near-surface-layer region 41b is greater than the content of Al in the inner region 41c.

The content of Si in the near-surface-layer region 41b is greater than the content of Si in the inner region 41c. Further, the content of Ba not bonded to P in the near-surface-layer region 41b is less than the content of Ba not bonded to P in the inner region 41c. Since the content of Ba not bonded to P in the near-surface-layer region 41b is less than that in the inner region 41c, the near-surface-layer region 41b exists as a region with a reduced content of Ba that is prone to leaching into the plating solution. This makes it possible to reduce leaching of the first glass 41.

According to the present example embodiment, the second glass 42 includes, for example, Si, Ba, and Al as its components. Unlike the first glass 41, the second glass 42 includes no compound in which Ba and P are bonded. The second glass 42 is located closer to the multilayer body 12 than the surface 33 of the base electrode layer 32. That is, the second glass 42 is not exposed on the surface 33 of the base electrode layer 32. Since the second glass 42 is not exposed on the surface 33 of the base electrode layer 32, the second glass 42 is not subjected to contact with the plating solution used in forming a plating layer on the base electrode layer 32. Therefore, for the second glass 42, a layer to reduce its erosion by the plating solution is not required, nor is treatment to form such a layer. Accordingly, unlike the first glass 41, the second glass 42 does not include the surface layer 41a that is insoluble in the plating solution. The second glass 42 does not include the near-surface-layer region 41b, either. In other words, the second glass 42 is provided by a layer generally equivalent to the inner region 41c of the first glass 41. The second glass 42 configured as mentioned above can, due to the presence therein of, for example, Si, Ba, and Al, contribute more to improved adhesion between the inner electrode layer 16 and the base electrode layer 32 than the first glass 41.

The first plating layer 34a and the second plating layer 34b, which constitute the plating layer 34 disposed on the base electrode layer 32, will now be described with reference to FIGS. 1 to 4.

The first plating layer 34a is disposed so as to cover the first base electrode layer 32a located at the first end surface 12e. Further, for example, the first plating layer 34a may be disposed so as to cover the first base electrode layer 32a located at the first major surface 12a, the second major surface 12b, the first side surface 12c, and the second side surface 12d. However, the first plating layer 34a may be disposed only on the first base electrode layer 32a located at the first end surface 12e.

The second plating layer 34b is disposed so as to cover the second base electrode layer 32b located at the second end surface 12f. Further, for example, the second plating layer 34b may be disposed so as to cover the second base electrode layer 32b at the first major surface 12a, the second major surface 12b, the first side surface 12c, and the second side surface 12d. However, that the second plating layer 34b may be disposed only on the second base electrode layer 32b located at the second end surface 12f.

Each of the first plating layer 34a and the second plating layer 34b may include at least one of, for example, Cu, Ni, Sn, Ag, Pd, an Ag—Pd alloy, or Au.

The plating layer 34 may include a plurality of layers. For example, the first plating layer 34a is of a two-layer structure including the first lower plating layer 34ai and the first upper plating layer 34a2 covering the first lower plating layer 34ai, and the second plating layer 34b is of a two-layer structure including the second lower plating layer 34b₁ and the second upper plating layer 34b2 covering the second lower plating layer 34b₁. Preferably, the first lower plating layer 34ai and the second lower plating layer 34b₁ are, for example, Ni plating layers, and the first upper plating layer 34a2 and the second upper plating layer 34b₂ are, for example, Sn plating layers.

The first and second lower plating layers 34ai and 34b₁, which are Ni plating layers, are provided to prevent the base electrode layer 32 from being eroded by the solder used when mounting the multilayer ceramic capacitor 10. The first and second upper plating layers 34a2 and 34b₂, which are Sn plating layers, are provided to improve the wettability of the solder used when mounting the multilayer ceramic capacitor 10 to thus facilitate the mounting.

The first and second lower plating layers 34ai and 34b₁, which are Ni plating layers, preferably have a thickness of, for example, greater than or equal to 1 μm and less than or equal to 15 μm. The first and second upper plating layers 34a2 and 34b₂, which are Sn plating layers, preferably have a thickness of, for example, greater than or equal to 1 μm and less than or equal to 15 μm.

The first and second upper plating layers 34a2 and 34b₂ may be omitted. The plating layer 34 may include, for example, the first and second upper plating layers 34a2 and 34b2 as its outermost layers, or may further include another plating electrode provided on the surface of each of the first and second upper plating layers 34a2 and 34b₂.

As for the multilayer ceramic capacitor 10 including the multilayer body 12 and the first and second outer electrodes 30a and 30b according to the present example embodiment, its dimension in the length direction z is defined as a dimension L, its dimension in the height direction x is defined as a dimension T, and its dimension in the width direction y is defined as a dimension W.

The multilayer ceramic capacitor 10 is dimensioned such that, for example, the dimension L in the length direction z is greater than or equal to 0.2 mm and less than or equal to 1.8 mm, the dimension W in the width direction y is greater than or equal to 0.1 mm and less than or equal to 1.0 mm, and the dimension T in the height direction x is greater than or equal to 0.1 mm and less than or equal to 1.0 mm. The dimensions of the multilayer ceramic capacitor 10 can be measured with a microscope.

A non-limiting example of a method for manufacturing a multilayer ceramic capacitor according to an example embodiment of the present invention will now be described.
(Step 1) First, dielectric sheets for forming the ceramic layers, and a conductive paste for forming the inner electrode layers are prepared. The dielectric sheets, and the conductive paste for forming the inner electrode layers each include a binder and a solvent. A known binder and a known solvent may be used in this case.
(Step 2) The conductive paste for forming the inner electrode layers is applied in a predetermined pattern onto the dielectric sheets by, for example, a method such as screen printing or gravure printing. As a result, dielectric sheets provided with the pattern of the first inner electrode layer, and dielectric sheets provided with the pattern of the second inner electrode layer are prepared.

As for the dielectric sheets, dielectric sheets used for forming the outer layer and provided with no pattern of the inner electrode layer printed thereon are also prepared.

A predetermined number of dielectric sheets used for forming the outer layer and provided with no pattern of the inner electrode layer printed thereon are stacked. On top of the resulting stack, the dielectric sheets provided with the pattern of the first inner electrode layer, and the dielectric sheets provided with the pattern of the second inner electrode layer are stacked sequentially to form a portion that will become the inner layer portion 14b. On top of the portion that will become the inner layer portion 14b, a predetermined number of dielectric sheets used for forming the outer layer and provided with no pattern of the inner electrode layer printed thereon are stacked. A sheet stack having the inner layer portion 14b and the outer layer portion is thus formed.
(Step 4) Subsequently, the sheet stack is pressed in the stacking direction by, for example, isostatic pressing or other methods, and a multilayer block is thus produced.
(Step 5) Subsequently, the multilayer block is cut into portions of a predetermined size to obtain individual multilayer chips. At this time, the corners and edges of the multilayer chips may be rounded by, for example, barrel finishing or other methods.
(Step 6) Subsequently, each multilayer chip is fired to produce the multilayer body 12. Although the firing temperature depends on the material of the dielectric ceramic layer or the material of the inner electrode layer, the firing temperature is preferably, for example, higher than or equal to 900 °C and lower than or equal to 1400 °C. Steps 1 to 6 correspond to the multilayer-body forming step.
(Step 7) Subsequently, the first outer electrode 30a and the second outer electrode 30b are respectively formed on the first end surface 12e and the second end surface 12f of the multilayer body 12. That is, first, the paste for forming the base electrode layer is applied and baked onto the first end surface 12e and the second end surface 12f of the multilayer body 12 to form the first base electrode layer 32a of the first outer electrode 30a and the second base electrode layer 32b of the second outer electrode 30b. The baking temperature is preferably, for example, higher than or equal to 700 °C and lower than or equal to 900 °C. The paste for forming the base electrode layer includes, for example, metal powder whose main component is Cu, and glass powder including Si, Ba, and Al as its components. As a result of the baking process mentioned above, the metal powder and the glass powder within the paste for forming the base electrode are now included as the conductive metal and the glass 40, respectively, in the base electrode layer 32.
(Step 8) The next step involves treatment of the glass 40 exposed on the surface of the base electrode layer 32. As a result of this treatment, the glass 40 including the first glass 41 and the second glass 42 is now included in the base electrode layer 32. This will be described below in more detail.

The multilayer body 12 with the base electrode layer 32 formed thereon is immersed in, for example, a pyrophosphate-based Cu plating solution with no electric current applied. In this regard, the pyrophosphate-based Cu plating solution has, for example, a pyrophosphate concentration greater than or equal to 0.02 mol/L and less than or equal to 3 mol/L, and a Cu concentration (Cu ion concentration) greater than or equal to 0.01 mol/L and less than or equal to 1.5 mol/L. More preferably, for example, the pyrophosphate concentration is greater than or equal to 0.1 mol/L and less than or equal to 2 mol/L, and the Cu concentration (Cu ion concentration) is greater than or equal to 0.05 mol/L and less than or equal to 1 mol/L. The pyrophosphate-based Cu plating solution is preferably stirred while the multilayer body 12 with the base electrode layer 32 formed thereon is immersed in the pyrophosphate-based Cu plating solution. As a result, as for the glass 40 in the base electrode layer 32, a portion of the glass 40 exposed on the surface 33 of the base electrode layer 32 is subjected to treatment with the pyrophosphate-based Cu plating solution. This facilitates formation of the first glass 41. At this time, the formation of the first glass 41 is facilitated when the temperature of the plating solution is in an approximate range of, for example, higher than or equal to 40 °C and lower than or equal to 95 °C.

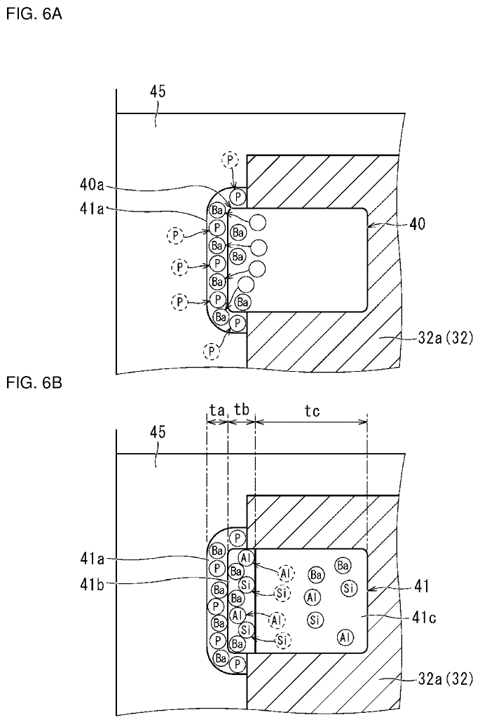

The first glass 41 is considered to be formed as described below when the multilayer body 12 with the base electrode layer 32 formed thereon is immersed in a pyrophosphate-based Cu plating solution. FIG. 6A schematically illustrates how a surface layer is formed in the first glass, and FIG. 6B schematically illustrates how a near-surface-layer region and an inner region are formed in the first glass.

First, the multilayer body 12 with the base electrode layer 32 formed thereon is immersed in a pyrophosphate-based Cu plating solution 45 with no electric current applied. As a result, an exposed portion 40a, which is a portion of the glass 40 exposed on the surface 33 of the base electrode layer 32, reacts with the pyrophosphate-based Cu plating solution 45. At this time, as illustrated in FIG. 6A, Ba near the exposed portion 40a of the glass 40 leaches into the pyrophosphate-based Cu plating solution 45. As the leached Ba reacts with P present in the pyrophosphate-based Cu plating solution 45, a compound in which Ba and P are bonded, that is, for example, the barium pyrophosphate 2.35-hydrate according to the present example embodiment, is formed on the surface of the exposed portion 40a of the glass 40. As a result, the first glass 41 having the surface layer 41a including the barium pyrophosphate 2.35-hydrate is formed.

Further, as Ba near the exposed portion 40a leaches into the pyrophosphate-based Cu plating solution 45, a Ba-depleted area is created at a location inside the surface layer 41a as illustrated in FIG. 6A. Si, Al, and other components migrate to the Ba-depleted area. For example, Si and Al migrate from a location including the Ba-depleted area, or migrate from a location that is closer to the multilayer body 12 than the Ba-depleted area. This results in formation of the following regions in the first glass 41: the near-surface-layer region 41b, which is formed as Si, Al, and other components migrate into the Ba-depleted area, and the inner region 41c, which is located closer to the multilayer body 12 than the near-surface-layer region 41b.

For example, the respective contents of Al, Si, Ba, and P in the surface layer 41a, the near-surface-layer region 41b, and the inner region 41c are as presented below.

TABLE 1

Mass % of components

| First glass | Al | Si | Ba | P |
|---|---|---|---|---|
| Surface layer | 0 to 5 | 0 to 5 | 45 to 75 | 5 to 25 |
| Near-surface- | 0 to 20 | 0 to 20 | 20 to 50 | 0 to 10 |
| layer region | | | | |
| Inner region | 0 to 20 | 0 to 30 | 30 to 60 | 0 to 10 |

In the surface layer 41a, the near-surface-layer region 41b, and the inner region 41c, the sum of the respective mass percentages of Al, Si, Ba, and P does not need to be equal to 100%. Rather, another element may be included in these regions. Such other element may be at least one selected from the group consisting of, for example, Li, Na, K, Be, Mg, Ca, Sr, Bi, Zn, Ga, Pb, Ti, Zr, Sn, Cu, Mn, Co, Ni, Fe, Nb, La, V, C, N, O, S, F, or Cl.

The surface layer 41a is mainly made of barium pyrophosphate hydrate. Accordingly, the surface layer 41a includes almost no Al and almost no Si, and the content of each of Al and Si in the surface layer 41a is, for example, less than or equal to 5 mass %.

The sum in mass % of the two elements, Ba and P, in the surface layer 41a is, for example, greater than or equal to 60 mass %. The remainder of the surface layer 41a is filled with, for example, oxygen, hydrates, and trace amounts of other elements. Each component in the glass 40 exists as an oxide, and the oxygen mentioned above also includes oxygen derived from Ba and P.

The respective contents of Al, Si, and Ba in the near-surface-layer region 41b and the inner region 41c satisfy the relationships (i) and (ii) below.
(i) Al and Si in the near-surface-layer region 41b>Al and Si in the inner region 41c
(ii) Ba in the near-surface-layer region 41b<Ba in the inner region 41c

In the near-surface-layer region 41b and the inner region 41c, it is not necessary for at least one of Al, Si, or Ba to have the highest mass %. For example, depending on the type of the glass, B may have the highest mass %.

Now, as illustrated in FIG. 6B, the thicknesses of individual layers in the first glass 41 are defined as follows. That is, the distance from the surface of the surface layer 41a to the surface of the near-surface-layer region 41b is defined as a thickness ta of the surface layer 41a, the distance from the surface of the near-surface-layer region 41b to the surface of the inner region 41c is defined as a thickness tb of the near-surface-layer region 41b, and the distance from the surface of the inner region 41c to the back of the first glass 41 is defined as a thickness tc of the inner region 41c. The ratio between the respective thicknesses of these layers is, for example, ta:tb:tc=1 to 33.3:1 to 33.3:33.3 to 98. In this regard, the surface refers to a side where the base electrode layer 32 is exposed, and the back refers to a side opposite from the side where the base electrode layer 32 is exposed.
(Step 9) Subsequently, the plating layer 34 is formed. According to the present example embodiment, the plating layer 34 is formed on the surface 33 of the base electrode layer 32. More specifically, for example, the Ni plating layer and the Sn plating layer are formed on the base electrode layer 32. In performing plating, although either electrolytic plating or electroless plating may be used, electroless plating requires pretreatment with a catalyst or the like to improve the plating deposition rate, which disadvantageously makes the overall process more complex. Therefore, it is usually preferable to use electrolytic plating. The plating method to be used is preferably barrel plating, for example.

The multilayer ceramic capacitor 10 according to the present example embodiment is thus manufactured as described above.

According to the above-described example embodiment, for convenience, the first glass 41 is divided into the following three regions: the surface layer 41a, the near-surface-layer region 41b, and the inner region 41c. However, the first glass 41 may include any layers, provided that the compound in which Ba and P are bonded is formed on the surface of the first glass 41. For example, the first glass 41 may be divided into any number of layers depending on differences in the contents of components such as Si, Al, or Ba.

According to the above-described example embodiment, the glass 40 includes the second glass 42 in addition to the first glass 41. However, the glass may include only the first glass. However, the inclusion of the second glass in the glass 40 is preferable, as this makes it possible to further improve the adhesion between the base electrode layer and the inner electrode layer.

With reference to the above-described example embodiment, a two-terminal multilayer ceramic capacitor including two terminals, the first outer electrode 30a, and the second outer electrode 30b, has been described as a multilayer ceramic electronic component. However, example embodiments of the present invention are not limited to a two-terminal multilayer ceramic capacitor but is applicable to any multilayer ceramic electronic component with outer electrodes. For example, example embodiments of the present invention may be applied to a three-terminal multilayer ceramic capacitor. Such a three-terminal multilayer ceramic capacitor includes the multilayer body 12 similar to that according to the above-described example embodiment, and first to fourth outer electrodes. The inner electrode layers 16 include first inner electrode layers and second inner electrode layers. The first inner electrode layers are extended to the first end surface 12e and the second end surface 12f. The second inner electrode layers are extended to the first side surface 12c and the second side surface 12d. The first outer electrode is disposed on the first end surface 12e of the multilayer body 12. The first outer electrode is electrically connected to the first inner electrode layers exposed on the first end surface 12e of the multilayer body 12. The second outer electrode is disposed on the second end surface 12f of the multilayer body 12. The second outer electrode is electrically connected to the first inner electrode layers exposed on the second end surface 12f of the multilayer body 12. The third outer electrode is disposed on the first side surface 12c of the multilayer body 12. The third outer electrode is electrically connected to the second inner electrode layers exposed on the first side surface 12c of the multilayer body 12. The fourth outer electrode is disposed on the second side surface 12d of the multilayer body 12. The fourth outer electrode is electrically connected to the second inner electrode layers exposed on the second side surface 12d of the multilayer body 12.

As with the above-mentioned example embodiment, each of the first to fourth outer electrodes includes a base electrode layer, a resin electrode layer, and a plating layer that are stacked in this order. The resin electrode layer includes a conductive filler and resin.

It is noted that numerical values, ratios, ranges, quantitative relationships, and positional relationships such as parallel, perpendicular, etc., described or recited herein are merely non-limiting examples unless otherwise expressly stated in the description or claims, and include within the scope thereof inherent imprecision associated with manufacturing tolerances, measurement tolerances, and the practical limitations of the instruments and techniques used to determine such values, ratios, ranges, quantitative relationships, and positional relationships, as would be understood by a person of ordinary skill in the relevant art, and further encompass a variation that is reasonable and customary in the relevant art or field of technology for the type of measurement or parameter at issue.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of ceramic layers and a plurality of inner electrode layers; and
an outer electrode connected to the plurality of inner electrode layers at a location where the plurality of inner electrode layers are exposed from the multilayer body; wherein
the outer electrode includes a base electrode layer, and a plating layer on the base electrode layer;
the base electrode layer includes a conductive metal, and a glass including Si and Ba;
the glass includes a first glass;
the first glass includes:
a surface layer including a compound in which Ba and P are bonded in a portion of the first glass exposed from a surface of the base electrode layer; and
a near-surface-layer region located adjacent to the surface layer, the near-surface-layer region being located in at least one of a location inside the surface layer or a location that is closer to the multilayer body than the surface layer; and
the near-surface-layer region includes a content of the compound less than a content of the compound in the surface layer.

2. The multilayer ceramic capacitor according to claim 1, wherein a content of Ba not bonded to P in the near-surface-layer region is greater than a content of Ba not bonded to P in the surface layer.

3. The multilayer ceramic capacitor according to claim 1, wherein a content of Si in the near-surface-layer region is greater than a content of Si in the surface layer.

4. The multilayer ceramic capacitor according to claim 1, wherein
the glass further includes Al; and
a content of Al in the near-surface-layer region is greater than a content of Al in the surface layer.

5. The multilayer ceramic capacitor according to claim 1, wherein
the first glass further includes an inner region in an interior of the base electrode layer, the inner region being located adjacent to the near-surface-layer region and closer to the multilayer body than the near-surface-layer region;
a content of Si in the near-surface-layer region is greater than a content of Si in the inner region; and
a content of Ba not bonded to P in the near-surface-layer region is less than a content of Ba not bonded to P in the inner region.

6. The multilayer ceramic capacitor according to claim 5, wherein
the glass further includes Al; and
a content of Al in the near-surface-layer region is greater than a content of Al in the inner region.

7. The multilayer ceramic capacitor according to claim 1, wherein the glass further includes a second glass that does not include the compound, the second glass being located closer to the multilayer body than the surface of the base electrode layer.

8. The multilayer ceramic capacitor according to claim 1, wherein the compound includes a barium pyrophosphate 2.35-hydrate.

9. The multilayer ceramic capacitor according to claim 1, wherein
the plating layer includes a lower plating layer, and an upper plating layer on a surface of the lower plating layer; and
the lower plating layer includes a Ni plating layer, and the upper plating layer includes a Sn plating layer.

10. A method for manufacturing a multilayer ceramic capacitor, the method comprising:
preparing a multilayer body including a plurality of ceramic layers and a plurality of inner electrode layers;
forming a base electrode layer on the multilayer body, the base electrode layer including a conductive metal and a glass;
forming a first glass as a portion of the glass by immersing, in a solution including P, the multilayer body on which the base electrode layer is formed; and
forming, by forming a plating layer on the base electrode layer, an outer electrode including a stack of the plating layer and the base electrode layer; wherein
the first glass includes:
a surface layer including a compound in which Ba and P are bonded in a portion of the first glass exposed from a surface of the base electrode layer; and
a near-surface-layer region located adjacent to the surface layer, the near-surface-layer region being located in at least one of a location inside the surface layer or a location that is closer to the multilayer body than the surface layer; and
the near-surface-layer region includes a content of the compound less than a content of the compound in the surface layer.

11. The method for manufacturing a multilayer ceramic capacitor according to claim 10, wherein the base electrode layer includes Cu as the conductive metal.

12. The method for manufacturing a multilayer ceramic capacitor according to claim 10, wherein the solution including P includes a pyrophosphate-based Cu plating solution.

13. The method for manufacturing a multilayer ceramic capacitor according to claim 10, wherein a content of Ba not bonded to P in the near-surface-layer region is greater than a content of Ba not bonded to P in the surface layer.

14. The method for manufacturing a multilayer ceramic capacitor according to claim 10, wherein a content of Si in the near-surface-layer region is greater than a content of Si in the surface layer.

15. The method for manufacturing a multilayer ceramic capacitor according to claim 10, wherein
the glass further includes Al; and
a content of Al in the near-surface-layer region is greater than a content of Al in the surface layer.

16. The method for manufacturing a multilayer ceramic capacitor according to claim 10, wherein
the first glass further includes an inner region in an interior of the base electrode layer, the inner region being located adjacent to the near-surface-layer region and closer to the multilayer body than the near-surface-layer region;
a content of Si in the near-surface-layer region is greater than a content of Si in the inner region; and
a content of Ba not bonded to P in the near-surface-layer region is less than a content of Ba not bonded to P in the inner region.

17. The method for manufacturing a multilayer ceramic capacitor according to claim 16, wherein
the glass further includes Al; and
a content of Al in the near-surface-layer region is greater than a content of Al in the inner region.

18. The method for manufacturing a multilayer ceramic capacitor according to claim 10, wherein the glass further includes a second glass that does not include the compound, the second glass being located closer to the multilayer body than the surface of the base electrode layer.

19. The method for manufacturing a multilayer ceramic capacitor according to claim 10, wherein the compound includes a barium pyrophosphate 2.35-hydrate.

20. The method for manufacturing a multilayer ceramic capacitor according to claim 10, wherein
the plating layer includes a lower plating layer, and an upper plating layer on a surface of the lower plating layer; and
the lower plating layer includes a Ni plating layer, and the upper plating layer includes a Sn plating layer.
